(19) United States
(12) Patent Application Publication
(10) Pub. No.: US 2025/0244697 A1
(43) Pub. Date: Jul. 31, 2025

(54) IMAGE FORMING APPARATUS

(71) Applicant: CANON KABUSHIKI KAISHA, Tokyo (JP)

(72) Inventor: KOHEI SHIMOSAWA, Kanagawa (JP)

(21) Appl. No.: 19/037,549

(22) Filed: Jan. 27, 2025

(30) Foreign Application Priority Data
Jan. 27, 2024 (JP) 2024-010625

(51) Int. Cl. G03G 15/16

(52) U.S. Cl. CPC G03G 15/1615; G03G 2215/00156

(57) ABSTRACT

An image forming apparatus includes an image bearing member, a first belt, a driving roller, a first driving source, an inner roller, a second belt, a transfer roller for nipping the first belt and the second belt and for transferring a toner image from the first belt onto the recording material, a downstream roller provided to contact an inner peripheral surface of the second belt on a side downstream of the transfer roller with respect to a recording material conveying direction and for forming a surface, on which the recording material is conveyed, between itself and the transfer roller, and a second driving source for rotationally driving the downstream roller. During transfer in which the toner image is transferred onto the recording material, a surface speed of the downstream roller is set to become higher than an inner peripheral surface speed of the second belt.

### FIELD OF THE INVENTION AND RELATED ART

The present invention relates to an image forming apparatus, such as a copying machine, a printer, a facsimile machine, or a multi-function machine having a plurality of functions of these machines, using an electrophotographic type or an electrostatic recording type.

In the image forming apparatus using the electrophotographic type or the like, a toner image formed on an image bearing member such as a photosensitive drum or an intermediary transfer belt is transferred onto a recording material. The toner image on the intermediary transfer belt is electrostatically transferred onto the recording material by nipping the recording material in a transfer portion by the image bearing member and a transfer device and by forming a transfer electric field in the transfer portion. As this transfer device, a transfer device with a belt transfer constitution in which a transfer belt for conveying the recording material while carrying the recording material is provided is employed in some instances since a separation performance of the recording material from the image bearing member is high or the like. The transfer device with the belt transfer constitution is constituted by including an endless transfer belt and a plurality of stretching rollers for stretching the transfer belt.

In Japanese Laid-Open Patent Application No. 2000-347517, a constitution in which on a side downstream of a secondary transfer portion, a secondary transfer belt which is the transfer belt is contacted so as to extend along rollers supporting the intermediary transfer belt which is the image bearing member and the recording material is adsorbed to and separated from the secondary transfer belt is proposed.

The transfer device with the belt transfer constitution has a constitution, for the purpose of cost reduction and space saving, such that first and second stretching rollers of two in number which is a necessary minimum number for stretching the transfer belt, in some instances. The first stretching roller is a transfer roller contacting the image bearing member through the transfer belt and for transferring the toner image from the image bearing member onto the recording material. Further, the second stretching roller is a separation roller for forming a belt surface, between itself and the transfer roller, on which the recording material on the transfer belt is conveyed, and in addition, for separating the recording material from the belt surface by utilizing curvature thereof and for conveying the recording material toward a downstream side.

Here, in the image forming apparatus, by an impact when the recording material enters the transfer portion, a speed of the image bearing member is fluctuated, so that a phenomenon that an image deterioration occur is generated in some instance. In order to solve this problem, hardness of an elastic member constituting the transfer roller is made low and a function as an impact absorbing material is imparted to the transfer roller, so that it is possible to suppress the image deterioration.

However, in the case where the transfer roller low in hardness is used, a strong stretching force is exerted on a low-hardness member of the transfer roller in a portion where the transfer belt is extended and stretched, so that the low-hardness member is elastically deformed in some instances. When this state is maintained for a long term, the low-hardness member is elastically deformed in the portion where the transfer belt is extended and stretched, so that the state becomes a factor such that a periodical density difference appears when an image is formed.

On the other hand, in a state in which the stretching force is weak, the transfer belt loosens, so that there is a possibility that periodical displacement (waving) in an out-of-plane direction on the belt surface on which the recording material is conveyed. By this, electric discharge occurs in a gap generated between the transfer belt and the recording material, and therefore, there is a possibility that unfixed toner scatters from the recording material and causes an abnormal image.

Further, for example, in the transfer device in which the transfer belt is stretched by the two stretching rollers, it is difficult to provide a mechanism for alleviating tension of the transfer belt or the like.

Thus, in a constitution in which as the first stretching roller in the transfer device in which the transfer belt is stretched by the two stretching rollers, the low-hardness transfer roller is used, or in the like constitution, it has been required that waving of the transfer belt is suppressed.

### SUMMARY OF THE INVENTION

Therefore, a principal object of the present invention is to suppress waving of a surface on which a recording material on a transfer belt is conveyed while suppressing permanent deformation of the transfer roller.

This object is accomplished by an image forming apparatus according to the present invention.

According to an aspect of the present invention, there is provided an image forming apparatus comprising: a rotatable image bearing member configured to bear a toner image; an endless first belt onto which the toner image is transferred from the image bearing member; a driving roller configured to drive the first belt; a first driving source configured to drive the driving roller; an inner roller configured to contact an inner surface of the first belt; an endless second belt configured to convey a recording material and configured to form a transfer portion where the toner image is transferred from the first belt onto the recording material; a transfer roller configured to contact an inner surface of the second belt and configured to nip the first belt and the second belt between itself and the inner roller and configured to form the transfer portion; a downstream roller provided so as to contact an inner peripheral surface of the second belt on a side downstream of the transfer roller with respect to a recording material conveying direction and configured to form a surface, on which the recording material is conveyed, between itself and the transfer roller; and a second driving source configured to rotationally drive the downstream roller, wherein during transfer in which the toner image is transferred onto the recording material, a surface speed of the downstream roller is set so as to become higher than an inner peripheral surface speed of the second belt.

According to another aspect of the present invention, there is provided an image forming apparatus comprising: a rotatable image bearing member configured to bear a toner image; an endless first belt onto which the toner image is transferred from the image bearing member; an inner roller configured to contact an inner surface of the first belt; an endless second belt configured to convey a recording material and configured to form a transfer portion where the toner image is transferred from the first belt onto the recording material; a transfer roller configured to contact an inner surface of the second belt and configured to nip the first belt and the second belt between itself and the inner roller and configured to form the transfer portion; a downstream roller provided so as to contact an inner peripheral surface of the second belt on a side downstream of the transfer roller with respect to a recording material conveying direction and configured to form a surface, on which the recording material is conveyed, between itself and the transfer roller; a first driving source configured to rotationally drive the transfer roller; and a second driving source configured to rotationally drive the downstream roller, wherein during transfer in which the toner image is transferred onto the recording material, a surface speed of the downstream roller is set so as to become higher than an inner peripheral surface speed of the second belt.

Further features of the present invention will become apparent from the following description of exemplary embodiments with reference to the attached drawings.

### BRIEF DESCRIPTION OF THE DRAWINGS

FIG. 1 is a schematic sectional view of an image forming apparatus.

FIG. 2 is a schematic sectional view in the neighborhood of a secondary transfer device.

FIG. 3 is a schematic sectional view in the neighborhood of the secondary transfer device for illustrating a drive form of a secondary transfer belt.

FIG. 4 is a graph showing a waving suppressing effect of the secondary transfer belt.

Parts (a) and (b) of FIG. 5 are schematic sectional view and top (plan) view, respectively, for illustrating another example of the drive form of the secondary transfer belt.

### DESCRIPTION OF THE EMBODIMENTS

In the following, an image forming apparatus according to the present invention will be described further specifically with reference to the drawings.

### Embodiment 1

### <Constitution and Operation of Image Forming Apparatus>

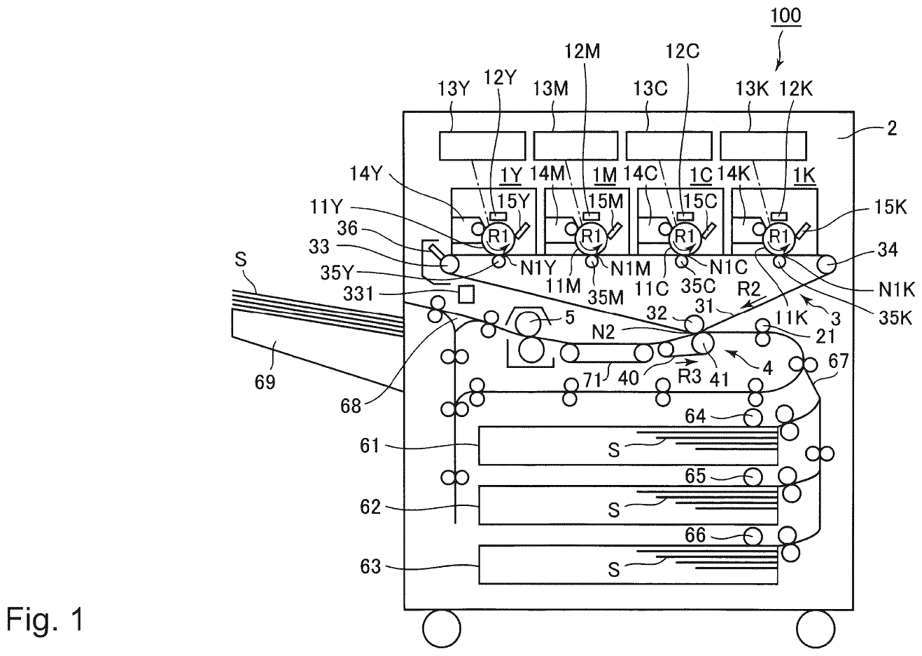

FIG. 1 is a schematic sectional view of an image forming apparatus 100 of an embodiment 1. The image forming apparatus 100 of this embodiment is a tandem-type printer employing an intermediary transfer type in which a full-color image can be formed using an electrophotographic type. The image forming apparatus 100 is capable of forming an image on the recording material S depending on an image signal transmitted from an external device.

Incidentally, as regards the image forming apparatus 100 and elements thereof, a front side of a paper surface of FIG. 1 refers to as a “front” side, and a rear side of the paper surface refers to as a “rear” side. A front-rear direction connecting the front side and the rear side is substantially parallel to rotational axis directions of a photosensitive drum 11, stretching rollers for an intermediary transfer belt 31, and stretching rollers for a secondary transfer belt 40 which are described later. Further, as regards the image forming apparatus 100 and elements thereof, an up-down direction includes an upward direction and a downward direction in a gravitation direction (vertical direction), but does not mean only directions toward immediately above and immediately below and includes directions on an upper side and a lower side with respect to a horizontal plane passing through a noted position or a noted element. Further, a recording material S is referred to as “paper” in some instances, but the recording material S is not limited to the paper. The recording material S may be constituted by materials other than the paper or materials containing the material other than the paper, inclusive of, for example, special paper such as synthetic paper or film constituted materials principally containing synthetic resins, and deposited paper having a metal layer, and the like.

The image forming apparatus 100 includes four image forming portions 1Y, 1M, 1C, and 1K for forming images of colors of yellow (Y), magenta (M), cyan (C), and black (K), respectively. The image forming portions 1Y, 1M, 1C, and 1K are linearly provided along a movement direction of an image transfer surface disposed substantially parallel to the intermediary transfer belt 31 described later. Incidentally, as regards elements having identical or corresponding functions or constitutions provided for the associated colors, those elements are collectively described by omitting suffixes Y, M, C, and K of reference numerals or symbols each showing the element for the associated color. In this embodiment, the image forming portion 1 is constituted by including the photosensitive drum 11, a charger 12, an exposure device 13, a developing device 14, a drum cleaning device 15, and the like which are described later.

The photosensitive drum 11 which is a rotatable drum-type (cylindrical) photosensitive member (electrophotographic photosensitive member) as a first image bearing member is rotationally driven in an arrow R1 direction (counterclockwise direction) in FIG. 1. A surface of the rotating photosensitive drum 11 is electrically charged uniformly to a predetermined polarity (negative polarity in this embodiment) and a predetermined potential by the charger 12 as a charging means. The charged surface of the photosensitive drum 11 is subjected to scanning exposure by being irradiated with imagewise light depending on image information by the exposure device (laser scanner) 13 as an exposure means, so that an electrostatic latent image (electrostatic image) is formed on the photosensitive drum 11.

The electrostatic latent image formed on the photosensitive drum 11 is developed (visualized) by being supplied with toner as a developer by the developing device 14 as a developing means, so that a toner image is formed on the photosensitive drum 11. In this embodiment, on an exposure portion (image portion) on the photosensitive drum 11 lowered in absolute value of the potential by being exposed to light depending on the image information after being charged uniformly, the toner charged to the same polarity (negative polarity in this embodiment) as a charge polarity of the photosensitive drum 11 is deposited (reverse development type). In this embodiment, a normal charge polarity of the toner, which is a principal charge polarity of the toner during the development is the negative polarity.

The intermediary transfer belt 31 which is an intermediary transfer member constituted by a rotatable endless belt as a second image bearing member is disposed so as to oppose the four photosensitive drums 11. The intermediary transfer belt 31 is stretched by a driving roller 33, a tension roller 34, and a secondary transfer opposite roller 32 which are used as a plurality of stretching rollers (supporting rollers). In this embodiment, the intermediary transfer belt 31 includes a base layer formed by using a resin material such as polyimide or polycarbonate, and a surface layer formed by using a rubber material. To an end portion of the rotational axis direction of the driving roller 33, a motor 331 which is a driving source constituting a driving device (not shown) as a driving means for rotating the driving roller 33. The driving device for the driving roller 33 is constituted by including, in addition to the motor 331, a drive transmitting member and the like. The driving device for the driving roller 33 is operated by being controlled by a controller (not shown) provided in the image forming apparatus 100.

The intermediary transfer belt 31 is rotated (circulated and moved) in an arrow R2 direction (clockwise direction) in FIG. 1 by transmitting thereto a driving force through rotational drive of the driving roller 33. The tension roller 34 imparts predetermined tension in a conveying direction (rotational direction, surface movement direction, traveling direction) of the intermediary transfer belt 31. The secondary transfer opposite roller 32 forms a secondary transfer portion N2 described later in cooperation with a secondary transfer roller (outer secondary transfer roller) 41 described later. On an inner peripheral surface side of the intermediary transfer belt 31, correspondingly to the photosensitive drums 11Y, 11M, 11C, and 11K, primary transfer rollers 35Y, 35M, 35C, and 35K which are roller-type primary transfer members as primary transfer means are provided, respectively. In this embodiment, the primary transfer rollers 35Y, 35M, 35C, and 35K are disposed in positions opposing the photosensitive drums 11Y, 11M, 11C, and 11K, respectively. The primary transfer roller 35 pressed toward the photosensitive drum 11 and is contacted to the photosensitive drum 11 through the intermediary transfer belt 31, and forms a primary transfer portion (primary transfer nip) N1 which is a region in which the photosensitive drum 11 and the intermediary transfer belt 31 are in contact with each other. The stretching rollers, other than the driving roller 33, for the intermediary transfer belt 31 and the primary transfer rollers 35 are rotated by following rotation of the intermediary transfer belt 31.

The toner image formed on the photosensitive drum 11 is transferred (primarily transferred) in the primary transfer portion N1 onto the rotating intermediary transfer belt 31. During a primary transfer step, to the primary transfer roller 35, a primary transfer voltage (primary transfer bias) which is a DC voltage of an opposite polarity (positive polarity in this embodiment) to a normal charge polarity of the toner is applied. For example, during full-color image formation, the toner images of the colors of yellow, magenta, cyan, and black are successively transferred superposedly onto the intermediary transfer belt 31 in the same image position.

On an outer peripheral surface side of the intermediary transfer belt 31, in a position opposing the secondary transfer opposite roller 32 as an opposing member, a secondary transfer device 4 is provided. The secondary transfer device 4 includes a secondary transfer belt 40 constituted by an endless belt and the secondary transfer roller 41 provided in a position opposing the secondary transfer opposite roller 32 on an inner peripheral surface side of the secondary transfer belt 40. The secondary transfer roller 41 is pressed toward the secondary transfer opposite roller 32 and contacts the secondary transfer opposite roller 32 through the secondary transfer belt 40 and the intermediary transfer belt 31. By this, the secondary transfer roller 41 forms a secondary transfer portion (secondary transfer nip) N2 which is a region in which the intermediary transfer belt 31 and the secondary transfer belt 40 are in contact with each other. The toner image formed on the intermediary transfer belt 31 is transferred (secondarily transferred) onto the recording material S nipped and conveyed in the secondary transfer portion N2 by the intermediary transfer belt 31 and the secondary transfer belt 40. During a secondary transfer step, to the secondary transfer opposite roller 32, a secondary transfer voltage (secondary transfer bias) which is a DC voltage of the same polarity (negative polarity in this embodiment) as the normal charge polarity of the toner is applied. The secondary transfer roller 41 is electrically grounded (connected to a ground potential). Incidentally, the secondary transfer opposite roller 32 may be electrically grounded, and a secondary transfer voltage of an opposite polarity to the normal charge polarity of the toner may be applied to the secondary transfer roller 41. The secondary transfer device 4 will be described further specifically later.

The recording materials (transfer materials, recording media, sheets) S are stored in paper feeding cassettes 61, 62, and 63 as recording material accommodating portions. The recording material is fed to a paper feeding and conveying path 67 as a recording material conveying path by rotating either one of paper feeding rollers 64, 65 and 66 as a feeding member, and then conveyed toward registration roller pair 21 as a conveying member. This recording material S is conveyed by the registration roller pair 21 toward the secondary transfer portion N2 by being timed to the toner image on the intermediary transfer belt 31.

The recording material S on which the toner image is transferred is conveyed to a fixing device 5 as a fixing means by the secondary transfer belt 40 and a conveying belt 71 as a conveying means. The fixing device 5 heats and presses the recording material S on which an unfixed toner image is carried, and thus fixes (melts, sticks) the toner image on the recording material S. The recording material S on which the toner image is fixed passes through a paper discharge conveying path 68 and is discharged (outputted) to a paper discharge tray 69 as a discharge portion.

Further, toner (primary transfer residual toner) remaining on the photosensitive drum 11 after a recording material transfer step is removed and collected from the surface of the photosensitive drum 11 by a drum cleaning device 15 as a cleaning means. Further, a deposited matter such as toner (secondary transfer residual toner) remaining on the intermediary transfer belt 31 after a secondary transfer step is removed and collected from the surface of the intermediary transfer belt 31 by a belt cleaning device 36 as a cleaning means.

Incidentally, in each of the image forming portions 1, the photosensitive drum 11, the charger 12, the developing device 14, and the drum cleaning device 15 are integrally assembled into a cartridge singly or in plurality, and may be made detachably mountable to an apparatus main assembly 2 of the image forming apparatus 100. Further, the intermediary transfer belt 31, the stretching rollers for the intermediary transfer belt 31, the primary transfer rollers 35, and the belt cleaning device 36 constitute an intermediary transfer belt unit 3. The intermediary transfer belt unit 3 may be made detachably mountable to the apparatus main assembly 2 of the image forming apparatus 100.

Further, in this embodiment, the image forming apparatus 100 has a constitution in which the fed recording material S is conveyed in the secondary transfer portion N2 from the right to the left as shown in FIG. 1, but is not limited to this direction, and may also have a constitution in which the recording material S is conveyed from the left to the right.

### <Constitution of Secondary Transfer Device>

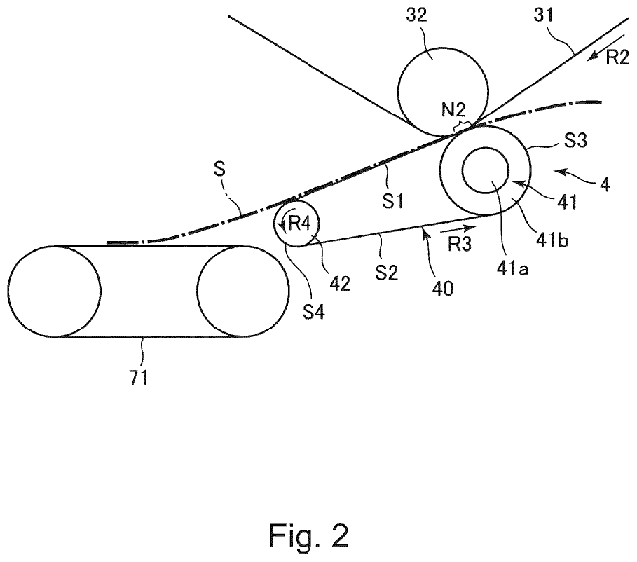

Next, a constitution of the secondary transfer device 4 in this embodiment will be further described. FIG. 2 is a schematic sectional view (showing a cross section substantially perpendicular to rotational axis directions of the secondary transfer roller 41 and a separation roller 42) showing the neighborhood of the secondary transfer device 4 in this embodiment. Incidentally, as regards the secondary transfer belt 40 and the stretching rollers for the secondary transfer belt 40, “upstream” and “downstream” refer to “upstream” and “downstream”, respectively, with respect to a conveying direction of the recording material S conveyed through the secondary transfer belt 40 or the secondary transfer portion N2.

The secondary transfer device 4 includes the secondary transfer belt (transfer belt) 40 constituted by an endless belt as a recording material carrying member. The secondary transfer belt 40 is stretched (supported) by a plurality of stretching rollers (supporting rollers). The secondary transfer device 4 includes the following two rollers provided as stretching rollers for the secondary transfer belt 40 on the inner peripheral surface side of the secondary transfer belt 40. That is, the two rollers are the secondary transfer roller 41 which is a transfer roller (transfer member) as a first stretching roller (first supporting roller) for forming the secondary transfer portion N2, and the separation roller 42 as a second stretching roller (second supporting roller). Each of the secondary transfer roller 41 and the separation roller 42 contacts the inner peripheral surface of the secondary transfer belt 40. That is, of the two rollers stretching the secondary transfer belt 40 from the inner peripheral surface side, the secondary transfer roller 41 forms the secondary transfer portion N2 by being press-contacted to the secondary transfer opposite roller 32 through the secondary transfer belt 40 and the intermediary transfer belt 31. Each of the stretching rollers for the secondary transfer belt 40 is rotatably supported (held) by a frame (not shown) constituting the secondary transfer device 4 in both (opposite) end portions thereof with respect to a rotational axis direction thereof.

The rotational axis directions of the secondary transfer roller 41 and the separation roller 42 are substantially parallel to each other.

The secondary transfer belt 40 is formed with a resin material such as polyimide, polycarbonate, or the like. The material constituting the secondary transfer belt 40 may be adjusted in electric resistance (for example, volume resistance of 1×10⁹ to 1×10¹⁴ Ω·cm) by containing an electroconductive agent or an antistatic agent in an appropriate amount. Further, the secondary transfer belt 40 may have a single-layer structure or a multi-layer structure. Further, the material constituting the secondary transfer belt 40 is not limited to the resin material, but the secondary transfer belt 40 may be formed with metal. Further, a peripheral length of the secondary transfer belt 40 is about 100 to 300 mm as an example.

The secondary transfer roller 41 is constituted by an elastic roller having a multi-layer structure. In this embodiment, the secondary transfer roller 41 is constituted by providing a foamable rubber layer (elastic layer) 41b constituted by a foamable rubber which is a dielectric member as a surface layer on an outer periphery of a core metal 41a which is a lowermost layer. In this embodiment, a hardness of the foamable rubber constituting the secondary transfer roller 41 is 25° or more and 50° or less in Asker-C hardness. By this, the secondary transfer roller 41 is lower in hardness than the secondary transfer opposite roller 32.

The secondary transfer roller 41 is contacted (pressed) together with the secondary transfer belt 40 by a pressing mechanism (not shown) to a portion of the secondary transfer opposite roller 32 around which the intermediary transfer belt 31 is wound. Thus, the secondary transfer roller 41 is press-contacted to the secondary transfer opposite roller 32 through the secondary transfer belt 40 and the intermediary transfer belt 31. In a contact portion between the secondary transfer opposite roller 32 around which the intermediary transfer belt 31 is wound and the secondary transfer roller 41 around which the secondary transfer belt 40 is wound, by a contact force thereof, a low-hardness foamable rubber layer (low-hardness member) 41b is elastically deformed. By this, the secondary transfer potion N2 which is a contact region between the intermediary transfer belt 31 and the secondary transfer belt 40.

Incidentally, it has been known that a speed fluctuation of the intermediary transfer belt 31 is generated by an impact when for example, a high-rigidity recording material S (thick paper or the like) enters the secondary transfer portion N2 and thus an image deterioration such that the toner image is transferred in the primary transfer portion N1 occurs in some cases. However, the secondary transfer roller 41 is made to have a sufficiently low hardness as described above, so that the impact during the entering of the recording material S is absorbed by the secondary transfer roller 41. For that reason, the speed fluctuation of the intermediary transfer belt 31 is made small, so that the image deterioration can be suppressed. In this embodiment, as described above, the hardness of the secondary transfer roller 41 is made lower than the hardness of the secondary transfer opposite roller 32.

In this embodiment, to the secondary transfer opposite roller 32, a potential of the same polarity as the normal charge polarity of the toner is imparted from an external energizing device (not shown) as a voltage applying means, and thus the secondary transfer roller 41 is electrically grounded, so that a secondary transfer electric field is formed in the secondary transfer portion. However, an energizing form to the secondary transfer portion N2 is not limited thereto, but the secondary transfer opposite roller 32 is electrically grounded, and to the secondary transfer roller 41, a potential of the opposite polarity to the normal charge polarity of the toner may be imparted.

The separation roller (downstream roller) 42 is disposed on a side downstream of the secondary transfer roller 41. By the separation roller 42 and the secondary transfer roller 41, a recording material conveying surface S1 which is a belt surface of the secondary transfer belt 40 on which the recording material S is carried and conveyed (herein, this surface is also referred to as an “upper surface” S1) is formed.

The recording material S passed through the secondary transfer portion N2 and conveyed by rotation of the secondary transfer belt 40 by being electrostatically adsorbed on an outer peripheral surface (from surface) which is the upper surface S1 of the secondary transfer belt 40 is peeled off from the secondary transfer belt 40 by utilizing curvature of the separation roller 42. By this, the recording material S is delivered from the secondary transfer belt 40 to a conveying belt 71.

Here, as described above, in the case where a low-hardness transfer roller is used, in a wound-around portion of the transfer belt, a state in which a strong stretching force is applied to a low-hardness member of the transfer roller is maintained for a long period, there is a possibility that the low-hardness member is permanently deformed in that portion. Further, when the low-hardness member of the transfer roller is permanently deformed, it becomes a factor such that a periodical density difference appears when the image is formed. Particularly, as in the secondary transfer device 4 in this embodiment, in a constitution in which the transfer belt is stretched by the two stretching rollers, a winding amount of the transfer belt around the transfer roller is large, and a stretching force exerted on a winding portion is liable to become large, and therefore, this constitution can be said as a constitution in which the permanent deformation of the low-hardness member is liable to generate. Further, in the transfer device having such a constitution, from viewpoints of cost reduction, space saving, and the like, it is different to provide a mechanism for loosening tension of the transfer belt.

Incidentally, from the viewpoints of cost reduction, space saving, and the like of the secondary transfer device 4, it is desirable that the stretches are only two rollers consisting of the secondary transfer roller 41 and the separation roller 42 as in this embodiment. However, the present invention is not limited to such a form. For example, in the secondary transfer device 4, a driving roller, a tension roller, a cleaning opposite roller, a steering roller, and the like may be separately provided. These additional rollers can be provided so as to contact the inner peripheral surface of the intermediary transfer belt 40 in portions other than between the secondary transfer roller 41 and the separation roller 42, and one or a plurality of these addition rollers can be provided. The driving roller is a roller for conveying the secondary transfer belt 40 in a circumferential direction. The tension roller is a roller for imparting the stretching force to the intermediary transfer belt 40. The cleaning opposite roller is a roller which is disposed in a position opposing a cleaning member for collecting toner deposited on the intermediary transfer belt 40 and to which the cleaning member is contacted through the secondary transfer belt 40 in the case where the cleaning member is provided in the secondary transfer device 4. Further, the steering roller is a roller for controlling movement of the secondary transfer belt 40 in a widthwise direction (direction substantially perpendicular to a surface movement direction) during conveyance.

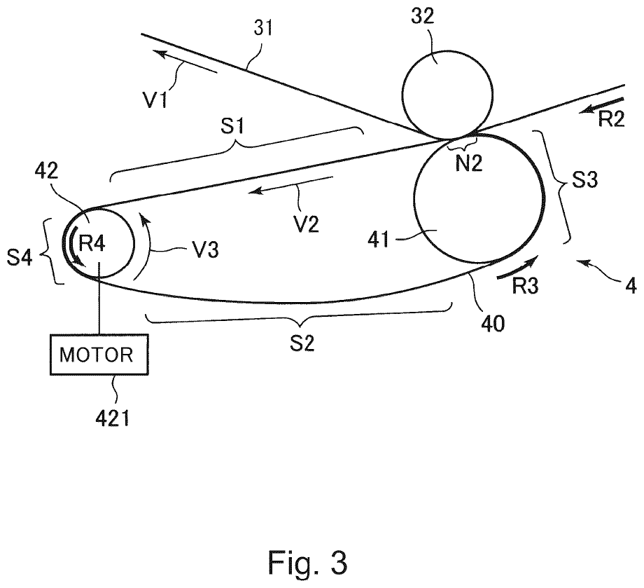

Next, using FIG. 3, a setting method of an axis-to-axis distance defined as an axial center distance between the secondary transfer roller 41 and the separation roller 42 in this embodiment will be described. FIG. 3 is a schematic sectional view (showing a cross section substantially perpendicular to the rotational axis directions of the secondary transfer roller 41 and the separation roller 42) showing the neighborhood of the secondary transfer device 4 in this embodiment.

First, in this embodiment, the secondary transfer belt 40 manufactured by die molding shows a circular cross section in a single article state in this embodiment. On the inner peripheral surface side of this secondary transfer belt 40, the stretching rollers are disposed, and the secondary transfer belt 40 is forcedly deformed in an elliptical shape, so that the secondary transfer device 4 is constituted.

In this embodiment, arrangement places, i.e., the axis-to-axis distance of the stretching rollers is set under a condition such that a relationship described below is maintained. Here, a length of the appear surface S1 of the secondary transfer belt 40 formed by the two stretching rollers (the secondary transfer roller 41 and the separation roller 42) is L1. A lower surface S2 of the secondary transfer belt 40 is L2. A length of a first winding portion S3 of the secondary transfer belt 40 wound around the secondary transfer roller 41 is L3. A length of a second winding portion S4 of the secondary transfer belt 40 wound around the separation roller 42 is LA. The upper surface S1, the lower surface S2, the first winding portion S3, the second winding portion S4, and the lengths L1, L2, L3, and LA are defined more specifically in the following manner.

The secondary transfer roller 41 and the separation roller 42 are disposed with an arbitrary axis-to-axis distance and are viewed substantially parallel to the rotational axis direction of the secondary transfer roller 41. Then, rectilinear lines which become tangential lines to outer diameter circles of the secondary transfer roller 41 and the separation roller 42 are drawn, and a contact point between each rectilinear line and each outer diameter circle is an end point of a line segment of the associated rectilinear line. In this case, the upper surface S1 is a portion corresponding to the line segment contacting the respective rollers on upper surface sides of the rollers. The lower surface S2 is a potion corresponding to the line segment contacting the respective rollers on lower surface sides of the rollers. The first winding portion S3 is a portion wound around the secondary transfer roller 41 so as to connect the upper surface S1 and the lower surface S2. Further, the second winding portion S4 is a portion wound around the separation roller 42 so as to connect the upper surface S1 and the lower surface S2. Accordingly, on the inner peripheral surface side of the secondary transfer belt 40, the length L1 of the upper surface S1, the length L2 of the lower surface S2, the length L3 of the first winding portion S3, and the length LA of the second winding portion S4 are as follows.
L1: line segment distance contacting upper surface side of respective rollers
L2: line segment distance contacting lower surface sides of respective rollers
L3: length of arc connecting end points of respective line segments corresponding to upper surface S1 and lower surface S2 on secondary transfer roller 41 side so as to extend along outer diameter circle of secondary transfer roller 41
L4: length of arc connecting end points of respective line segments corresponding to upper surface S1 and lower surface S2 on separation roller 42 side so as to extend along outer diameter circle of separation roller 42

Further, the axis-to-axis distance in the case where (inner peripheral length of secondary transfer belt 40)=L1+L2+L3+L4 holds is L. That is, the axis-to-axis distance in an ideal state such that the secondary transfer belt 40 is stretched without being flexed and there is no deformation or the like is L.

At this time, in this embodiment, the secondary transfer roller 41 and the separation roller 42 are disposed so that the axis-to-axis distance is L±5%, L±1.5%. Typically, the secondary transfer roller 41 and the separation roller 42 are disposed with the axis-to-axis distance such that a total length of L1, L2, L3, and L4 becomes the inner peripheral length or less of the secondary transfer belt 40 (i.e., the total length becomes equal to or shorter than the inner peripheral length.

In the case where the secondary transfer roller 41 and the separation roller 42 are disposed with the axis-to-axis distance set by the above-described method, the secondary transfer belt 40 forcedly deformed is in a state in which the secondary transfer belt 40 somewhat returns to an original circular shape, and typically causes loosening thereof. For that reason, to the first winding portion S3 wound around the secondary transfer roller 41, only a restoring force by which the deformed secondary transfer belt 40 returns to the original shape is substantially imparted. Accordingly, it becomes possible to suppress a risk such that the foamable rubber layer 41b of the secondary transfer roller 41 is permanently deformed.

Incidentally, the setting method of the axis-to-axis distance as described above is not limited to that the setting method is performed by fixing positions of the two stretching rollers to predetermined positions. Setting of the axis-to-axis distance may be made by fixing the position of one of the stretching rollers and by imparting a stretching force by using the other stretching roller in an axis-to-axis distance extending direction with a spring or the like which is an urging member as an urging means. However, there is a need to select a spring such that the foamable rubber layer 41b is not permanently deformed by the stretching force (a risk of permanent deformation of the foamable rubber layer 41b may only be required to be capable of being reduced to the same extent as that in the above-described case where the axis-to-axis distance is set by fixing the positions of the two stretching rollers). An initial stretching force capable of avoiding the permanent deformation of the foamable rubber layer 41b fluctuates also depending on hardness of the secondary transfer roller 41 and Young's modulus of the secondary transfer belt 40, and therefore, it is desirable the axis-to-axis distance and the spring force are appropriately set.

### <Driving Form of Stretching Rollers for Secondary Transfer Belt>

Next, using FIG. 3, a driving form of the stretching rollers for the secondary transfer belt 40 in this embodiment will be described.

The intermediary transfer belt 31 is conveyed in an arrow R2 direction (clockwise direction) in FIG. 3 by rotation of the driving roller 33, and in addition, rotates the secondary transfer belt 40 and the secondary transfer roller 41, which contact the intermediary transfer belt 31 in the secondary transfer portion N2, in a follower rotation manner. By this, the secondary transfer belt 40 is rotated (circulated and moved) in an arrow R3 direction in FIG. 3. In the secondary transfer portion (contact portion) N2, in the case where a friction coefficient between the intermediary transfer belt 31 and the secondary transfer belt 40 is sufficiently high and a load in the secondary transfer portion N2 with respect to a normal direction is sufficiently large, the intermediary transfer belt 31 and the secondary transfer belt 40 are strongly gripped each other. For that reason, a conveying speed V1 of the intermediary transfer belt 31 and a conveying speed V2 of the secondary transfer belt 40 coincide with each other. Or, the conveying speed V1 of the intermediary transfer belt 31 and the conveying speed V2 of the secondary transfer belt 40 substantially coincide with each other and at least the conveying speed V1 of the intermediary transfer belt 31 is not less than the conveying speed V2 of the secondary transfer belt 40. Further, a surface speed V3 of the separation roller V3 is faster than the conveying speed V1 of the intermediary transfer belt 31. That is, the following condition is satisfied.

(Surface speed V3 of separation roller 42)>(Conveying speed V1 of intermediary transfer belt 31)≥(Conveying speed V2 of secondary transfer belt 40)

Incidentally, the conveying speed V1 of the intermediary transfer belt 31 substantially coincide with a surface speed (outer peripheral surface speed, outer peripheral surface movement speed, peripheral speed) of the intermediary transfer belt 31. Further, the conveying speed V2 of the secondary transfer belt 40 substantially coincide with an inner peripheral surface speed (inner peripheral surface movement speed) of the secondary transfer belt 40. The surface speed V1 of the intermediary transfer belt 31 and the inner peripheral surface speed V2 of the secondary transfer belt 40 can be obtained on the basis of the number of rotations of a motor 331 (FIG. 1) for driving the driving roller 33 for rotating the intermediary transfer belt 31 and constitutions or the like of a drive transmitting member, the driving roller 33, the intermediary transfer belt 31, and the secondary transfer belt 40. However, the surface speed V1 of the intermediary transfer belt 31 and the inner peripheral surface speed V2 of the secondary transfer belt 40 may be directly measured.

To an end portion of the separation roller 42 with respect to the rotational axis direction of the separation roller 42, a motor 421 which is a driving source constituting a driving device (not shown) as a driving means for rotating the separation roller 42 is connected. The driving device for the separation roller 42 is constituted by including a drive transmitting member and the like in addition to the motor 421. The driving device for the separation roller 42 is operated by being controlled by a controller (not shown) provided in the image forming apparatus 100. The separation roller 42 is rotated in an arrow R4 direction (counterclockwise direction), i.e., in the same direction as a rotational direction of the secondary transfer belt 40 by impart thereto a driving force from the motor 421.

In a constitution of the secondary transfer device 4 including the stretching rollers (the secondary transfer roller 41 and the separation roller 42) disposed by the above-described axis-to-axis distance setting method, typically, the secondary transfer belt 40 is loosened, and therefore, there is a possibility that waving becomes conspicuous.

Therefore, in this embodiment, the number of rotations (rpm) of the motor 421 is set so that the surface speed (outer peripheral surface speed, outer peripheral surface movement speed, peripheral speed) V3 of the separation roller 42 becomes faster than the inner peripheral surface speed V2. By this, a state in which the surface (outer peripheral surface) of the separation roller 42 is slipped relative to the inner peripheral surface (back surface) of the secondary transfer belt 40 in a conveyance state is maintained, so that a dynamic frictional force is steadily imparted to the inner peripheral surface of the secondary transfer belt 40. This dynamic frictional force is imparted, as a force for pulling the upper side S1 of the secondary transfer belt 40, to the secondary transfer belt 40, and loosens the secondary transfer belt 40 at the lower surface S2 of the secondary transfer belt 40. That is, by imparting an additional stretching force to substantially only the upper surface S1 of the secondary transfer belt 40 for conveying the recording material S, the upper surface S1 is stabilized, so that it becomes possible to suppress a waving amount. Further, on the lower surface S2 of the secondary transfer belt 40, loosening occurs, and therefore, a stretching force exerted on the first winding portion S3 of the secondary transfer belt 40 wound around the secondary transfer roller 41 is small, so that the permanent deformation of the foamable rubber layer 41b of the secondary transfer roller 41 can be suppressed.

Incidentally, this speed relationship may only be required at least during image formation, more specifically, at least when the recording material S supplied for the image formation passes through the secondary transfer portion N2 and the upper surface S1 of the secondary transfer belt 40. Further, the surface speed V3 of the separation roller 42 can be obtained on the basis of the number of rotations of the motor 421 for driving the separation roller 42, and constitutions of a drive transmitting member and the separation roller 42. However, the surface speed V3 of the separation roller 42 may be directly measured.

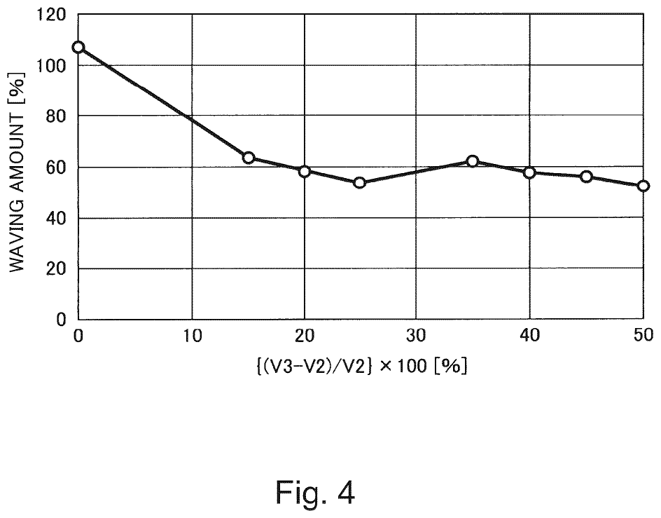

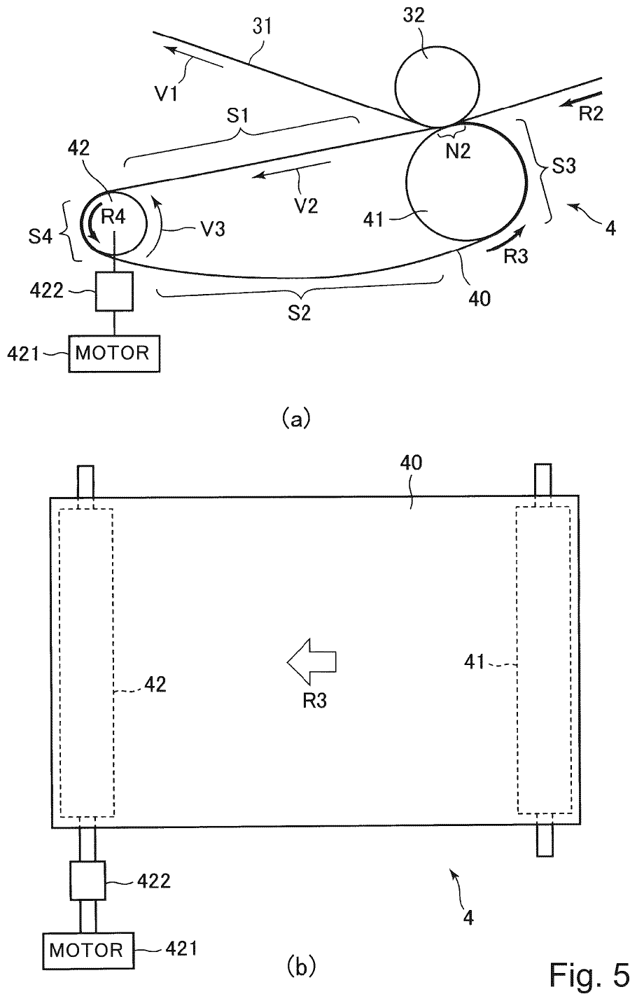

FIG. 4 is a graph showing a result such that a waving amount suppressing effect of the upper surface of the secondary transfer belt 40 was verified. Specifications of elements relating to the secondary transfer portion N2 used in this verification are as follows.

### (Intermediary Transfer Belt 31)

Surface layer material: chloroprene rubber
Base layer material: polyimide
Thickness: 355 μm
Conveying speed: 435 mm/s

### (Secondary Transfer Opposite Roller 32)

Surface layer material: electroconductive EPDM
Outer diameter: 16 mm
Rubber thickness: 0.5 mm
Hardness: JIS-A 70°

### (Secondary Transfer Belt 40)

Material: polyimide
Thickness: 85 μm

### (Secondary Transfer Roller 41)

Material: electroconductive sponge rubber
Outer diameter: 24 mm
Rubber thickness: 6 mm
Hardness: Asker-C 28°

### (Separation Roller 42)

Material: SUS
Outer diameter: 14 mm

In FIG. 4, an ordinate represents a ratio (%) of a maximum amplitude when a displacement amount of the upper surface S1 of the secondary transfer belt 40 in an out-plane direction is measured using a laser displacement meter. As regards this ratio, a waving amount under a condition such that drive is not imparted to the separation roller 42 and is rotated by following the secondary transfer belt 40 was defined as 100%. Further, an abscissa represents a speed ratio (%) of the surface speed V3 of the separation roller 42 to the inner peripheral surface speed V2 of the secondary transfer belt 40 (herein, this speed ratio is also simply referred to as a “speed difference” represented by the formula

$$\{ ( V 3 - V 2 ) / V 2 \} \times 10 \; 0 .$$

By making the speed difference 5% or more, a waving amount suppressing effect is obtained to some extent. Further, by making the speed difference 10% or more, the waving amount suppressing effect is further enhanced. Further, by making the speed difference 15% or more, a further good result such that the waving amount is suppressed to 60% was obtained. Further, it turned out that a suppressing amount of the waving amount is not largely changed even in further increase of the speed difference. This shows that in a region in which the speed difference is 15% or more, a stable dynamic frictional force is imparted to the upper surface S1 of the secondary transfer belt 40 and thus the dynamic frictional force has no dependency of the surface speed of the separation roller 42.

On the other hand, in the constitution of this verification, in a region in which the speed difference is less than 15%, abnormal noise occurred in the neighborhood of the separation roller 42 in some cases. It turned out that this noise is noise due to a chattering (shuddering) phenomenon of the secondary transfer belt 40. That is, a region in which the speed difference is small becomes a stick-slip region in which a state in which the surface of the separation roller 42 is slipped relative to the inner peripheral surface of the conveyed secondary transfer belt 40 and a state in which the surface of the separation roller 42 is gripped by the inner peripheral surface of the conveyed secondary transfer belt 40 are repeated. Further, from the verification, it also turned out that vibration by stick slip vibrates the secondary transfer belt 40 and is capable of causing an increase in waving amount. Incidentally, as described above, in the abscissa of FIG. 4, the waving amount in the case where the separation roller 42 is rotated by following the secondary transfer belt 40 is 100%, and in the above-described verification, the surface speed of the separation roller 42 at this time is somewhat slower than the inner peripheral surface speed of the secondary transfer belt 40. Further, the waving amount becomes somewhat large from that state until the speed difference becomes 0, and therefore, the waving amount when the speed difference is 0% becomes larger than 100%.

In order to enhance the waving suppressing effect, it is desirable that the number of rotations of the motor 421 capable of continuously imparting the dynamic frictional force is set. From a result of the verification as described above, the speed difference (={V3−V2)/V2}×100) of the surface speed V3 of the separation roller 42 relative to the inner peripheral surface speed V2 of the secondary transfer belt 40 is made at least 5% or more, preferably 10% or more, more preferably 15% or more. However, as described above, even when this speed difference is increased so as to exceed 15%, the waving suppressing effect is not largely changed in some instances. Further, for example, when this speed difference is made excessively large, it would be considered that a lifetime of the secondary transfer roller 41 is shortened due to abrasion of the inner peripheral surface of the secondary transfer roller 41, consumption of a driving system of the separation roller 42, and the like. For that reason, this speed difference is sufficient in many cases that the speed difference is 50% or less, and may preferably be 40% or less, more preferably be 30% or less.

However, it is assumed that a boundary between a dynamic friction region and the stick-slip region fluctuates due to a fluctuation of a friction coefficient between the secondary transfer belt 40 and the separation roller 42 with an increase in operation amount, a variation in axis-to-axis distance, flexure of the secondary transfer belt 40 with respect to the widthwise direction, and the like. For that reason, it is desirable that variations and fluctuations in elements relating to the frictional force are taken into consideration, and then, the number of rotations of the motor 421 is appropriately set.

Here, in order to provide the speed difference as described above, there is a need that the surface of the separation roller 42 is slipped relative to the inner peripheral surface of the secondary transfer belt 40. Requirements (frictional force relationship, normal reaction, friction coefficient) for that purpose will be described.

In the constitution of this embodiment, the secondary transfer belt 40 is rotated, and therefore, (1) the driving force for the intermediary transfer belt 31, and (2) the driving force for the separation roller 42 are transmitted to the secondary transfer belt 40.

In this case, (static frictional force F1 imparted to secondary transfer belt 40 by (1))=(friction coefficient between surface of intermediary transfer belt 31 and surface of secondary transfer belt 40)×(pressing force (normal resistance) for bringing secondary transfer opposite roller 32 into contact with secondary transfer roller 41) holds.

Further, (static frictional force F2 imparted to secondary transfer belt 40 by (2))=(friction coefficient between surface of separation roller 42 and inner peripheral surface of secondary transfer belt 40)×(restoring force (normal resistance) acting in inter-axis direction between secondary transfer roller 41 are separation roller 42 for returning elliptical-shaped secondary transfer belt 40 to circular-shaped secondary transfer belt 40) holds.

In the case of F1>F2, the secondary transfer belt 40 is slipped relative to the separation roller 42 (state in which the dynamic frictional force acts). Under the above-described condition, by setting the number of rotations of the motor 421 for driving the separation roller 42 so that (surface speed of separation roller 42)> (inner peripheral surface speed of secondary transfer belt 40) holds, a force in the conveying direction for pulling the secondary transfer belt 40 on the upper surface S1 side and loosening the secondary transfer belt 40 on the lower surface S2 side is imparted (a direction of actually imparted dynamic frictional force is an opposite direction).

In this embodiment, the separation roller 42 is constituted by a metal roller formed of SUS (stainless steel) which is metal, but the separation roller 42 is not limited to the metal roller. When a condition such that the surface of the separation roller 42 and the inner peripheral surface of the secondary transfer belt 40 slide each other as described above is satisfied, the separation roller 42 may be, for example, a roller provided with a roller portion of a solid rubber, a plastic roller, or the like.

Incidentally, the secondary transfer roller 41 is not limited to the follower rotation, but may be provided with a driving function. That is, the image forming apparatus 100 may include a driving source for imparting a driving force to the secondary transfer roller 41 independently of the driving source for the intermediary transfer belt 31 (further of the driving source for the separation roller 42). By this, an effect of suppressing a slip, between the recording material S and the intermediary transfer belt 31, which occurs in a state in which the recording material S small in surface friction coefficient enters the secondary transfer portion N2 and under a condition such that the toner amount is large is obtained. That is, by this slip, an image deterioration such that a length of the toner image in the conveying direction changes before and after the transfer is caused in some instances. On the other hand, by imparting the driving function to the secondary transfer roller 41, the secondary transfer belt 40 is conveyed independently of the intermediary transfer belt 31, and therefore, conveyance of the recording material S can be assisted in the secondary transfer portion N2. By this, the conveying speed of the intermediary transfer belt 31 and the conveying speed of the recording material S coincide with each other, and therefore, even in the case where the friction coefficient of the surface of the recording material S is small and under the condition such that the toner amount is large, the length of the toner image in the conveying direction is made constant and it becomes easy to transfer the toner image from the intermediary transfer belt 31 onto the recording material S. In this case, by setting the axis-to-axis distance and the stretching force so that the frictional force between the surface of the separation roller 42 and the inner peripheral surface of the secondary transfer belt 40 becomes smaller than the frictional force between the surface of the secondary transfer roller 41 and the inner peripheral surface of the secondary transfer belt 40 in the secondary transfer portion N2, the conveying speed of the secondary transfer belt 40 is controlled by a rotational speed of the secondary transfer roller 41. That is, during transfer of the toner image onto the recording material S, control is carried out so that the conveying speed V1 of the intermediary transfer belt 31 and the conveying speed V2 of the secondary transfer belt 40 substantially coincide with each other. Further, the surface speed V3 of the separation roller 42 is faster than the conveying speed V2 of the secondary transfer belt 40. Further, a surface speed V4 of the secondary transfer roller 41 is faster than the conveying speed V2 of the secondary transfer belt 40 and is slower than the surface speed V3 of the separation roller 42. That is, the following relationship is satisfied.

$$( Surface speed V 3 of seperation roller 42 ) > ( S urface speed V 4 of secondary transfer roller 41 ) \geq ( Converying speed V 2 of secondary transfer belt 40 )$$

Thus, in this embodiment, the image forming apparatus 100 includes the rotatable image bearing member (intermediary transfer belt) 31 for bearing the toner image, the endless belt (secondary transfer belt) 40 for conveying the recording material S while carrying the recording material S, the transfer roller 41 which is the transfer roller (secondary transfer roller) 41 for forming the transfer portion (secondary transfer portion) N2 where the toner image is transferred from the image bearing member 31 onto the recording material S and which is for rotating the belt 40 in cooperation with the image bearing member 31 by nipping the belt 40 between itself and the image bearing member 31, the downstream roller (separation roller 42 disposed so as to contact the inner peripheral surface of the belt 40 on the side downstream of the transfer roller 41 with respect to the conveying direction of the recording material S and forming the surface S1 on which the recording material S is conveyed between itself and the transfer roller 41, and the driving source (motor) 421 for rotationally driving the downstream roller 42 so that the downstream roller 42 is rotated in the same direction as the belt 40. The number of rotations of the driving source 421 during the image formation is set so that the surface speed V3 of the downstream roller 42 becomes faster than the inner peripheral surface speed V2 of the belt 40. In this embodiment, the transfer roller 41 includes the elastic layer 41b having the Asker-C hardness of 25° or more and 50° or less. Here, the number of rotations of the driving source 421 during the image formation is set so that the speed difference of the surface speed V3 of the downstream roller 42 relative to the inner peripheral surface speed V2 of the belt 40 becomes 5% or more and 50% or less, preferably 10% or more and 50% or less, more preferably 15% or more and 50% or less. Further, in this embodiment, the transfer roller 41 is rotated by following the rotation of the image bearing member 31. However, the transfer roller 41 may be rotationally driven independently of the image bearing member 31. Further, in this embodiment, the transfer belt 40 is supported by the two rollers consisting of the transfer roller 41 and the downstream roller 42.

Further, in this embodiment as viewed substantially parallel to the rotational axis direction of the transfer roller 41, when lengths of two layer segments, each including end points which are intersection points with outer diameter circles of the transfer roller 41 and the downstream roller 42, in two tangential lines circumscribed with the outer diameter circles of the transfer roller 41 and the downstream roller 42 so as not to intersect each other are L1 and L2, respectively, lengths of two arcs along the outer diameter circles of the transfer roller 41 and the downstream roller 42, respectively, so as to connect between the end points of the two line segments on a transfer roller side and so as to connect between the end points of the two line segments on a downstream roller side are L3 and LA, respectively, and an axis-to-axis distance between the transfer roller 41 and the downstream roller 42 in a case where a length of a sum of L1, L2, L3, and LA is equal to an inner peripheral length of the second belt is L, the transfer roller 41 and the downstream roller are provided in positions so that the axis-to-axis distance becomes L±5%. Further, typically, the total length of L1, L2, L3, and L4 is not less than the inner peripheral length of the belt 40. Further, in this embodiment, the image bearing member 31 is the intermediary transfer member for conveying the toner image, transferred from another image bearing member (photosensitive drum) 11, in order to transfer the toner image onto the recording material S in the transfer portion N2, and the transfer roller 41 contacts the opposite roller 32 disposed opposed to the transfer roller 41 while nipping the intermediary transfer member 40 therebetween.

As described above, in this embodiment, in the constitution including the two stretching rollers consisting of the low-hardness secondary transfer roller 41 and the separation roller 42, the separation roller 42 is rotated so that the surface speed of the separation roller 42 becomes faster than the inner peripheral surface speed of the secondary transfer belt 40. By this, while suppressing the permanent deformation of the low-hardness secondary transfer roller 41, it becomes possible to suppress the waving amount of the upper surface (recording material conveying surface) S1 which is the belt surface of the secondary transfer belt 40 on which the recording material S is conveyed. Accordingly, according to this embodiment, it is possible to suppress the occurrence of the image deterioration due to the permanent deformation of the secondary transfer roller 41 and the waving of the secondary transfer belt 40.

### Embodiment 2

Next, another embodiment (embodiment 2) of the present invention will be described. Basic constitution and operation of an image forming apparatus of this embodiment are the same as those of the image forming apparatus of the embodiment 1. Accordingly, elements having identical or corresponding functions or constitutions to those of the image forming apparatus of the embodiment 1 will be omitted from detailed description by adding thereto the same reference numerals or symbols as those in the embodiment 1.

Part (a) of FIG. 5 is a schematic sectional view showing the neighborhood of a secondary transfer device 4 in this embodiment (showing a cross section substantially perpendicular to rotation axis directions of the secondary transfer roller 41 and the separation roller 42). Part (b) of FIG. 5 is a schematic top (plan) view of the secondary transfer device 4 in this embodiment.

In this embodiment, a torque limiter 422 is provided in a drive transmitting portion as a drive transmitting means for transmitting a driving force from a motor 421 to the separation roller 42. That is, the torque limiter 422 is connected and disposed between the motor 421 and the separation roller 42.

By using the torque limiter, in the case where some abnormality occurs, an excessive force is prevented from being exerted on a driving system such as a driving source, so that the driving system can be protected. The torque limiter include a type in which in the case where a load not less than a limited torque is exerted, a driving force from the driving source is completely blocked, and a type in which in the case where the load not less than the limited torque is exerted on the torque limiter, the driving force is transmitted in a state in which the torque is maintained within the limited torque. In this embodiment, by using the latter, the separation roller 42 is maintained in a state in which the separation roller 42 is driven with a predetermined torque. For that reason, it becomes possible to impart an additional tension to the secondary transfer belt 40.

Also, in this embodiment, similarly as in the embodiment 1, the number of rotations of the motor 421 is set so that the surface speed V3 of the separation roller 42 becomes faster than the inner peripheral surface speed V2 of the secondary transfer belt 40.

Thus, in this embodiment, the torque limiter 422 is provided in the drive transmitting portion for transmitting the driving force from the driving source 421 to the downstream roller 42. Further, in this embodiment, the torque limiter 422 is constituted so as to be maintained in a state in which the downstream roller 42 is driven with a torque within a predetermined limited torque so that the surface speed V3 of the downstream roller 42 becomes faster than the inner peripheral surface speed V2 of the belt 40.

In the case where the load exerted on the torque limiter 422 is less than the limited torque, the driving force of the motor 421 is transmitted to the separation roller 42 with no magnification, and therefore, the number of rotations of the motor 421 and the number of rotations of the separation roller 42 become the same. That is, the surface speed V3 of the separation roller 42 becomes faster than the conveying speed V2 of the secondary transfer belt 40, and therefore, the waving suppressing effect similar to that in the embodiment 1 is obtained.

On the other hand, in the case where the load exerted on the torque limiter 422 is not less than the limited torque, the driving force transmitted from the motor 421 to the separation roller is limited. That is, the number of rotations of the separation roller 42 is below the number of rotations of the motor 421, so that the surface speed V3 of the separation roller 42 lowers, and for example, becomes equal to the inner peripheral surface speed V2 of the secondary transfer belt 40 in some instances. In this case, it is assumed that an additional tension imparted from the surface of the separation roller 42 to the inner peripheral surface of the secondary transfer belt 40 becomes small and thus a sufficient where suppressing effect cannot be obtained. For that reason, it is desirable that an additional tension necessary to obtain a desired waving suppressing effect is taken into consideration and then the limited torque of the torque limiter is set. By this, unless some abnormality occurs, the torque limiter 422 does not reduce an additional tension imparting effect by the separation roller 42.

### Other Embodiments

As described above, the present invention was described based on the specific embodiments, but the present invention is not limited to the above-described embodiments.

In the above-described embodiments, the intermediary transfer member was the intermediary transfer belt constituted by the endless belt, but for example, an intermediary transfer drum in which a sheet (film) is applied to a frame and is formed in a drum shape. In this case, the secondary transfer roller contacts the secondary transfer opposite roller, disposed opposed to the secondary transfer roller while nipping the sheet constituting the intermediary transfer drum therebetween, through the sheet.

Further, in the above-described embodiments, the case where the present invention is applied to the secondary transfer device in which the toner image is transferred from the intermediary transfer member as the image bearing member onto the recording material was described, but the present invention is not limited to the above-described embodiments. For example, the present invention may also be applied to a transfer device for transferring the toner image from a photosensitive member as the image bearing member onto the recording material in a monochromatic image forming apparatus. That is, the image bearing member to which the transfer belt is contacted is not limited to the intermediary transfer belt, but may also be the photosensitive member. Further, the image bearing member may also be an electrostatic recording dielectric member (electrostatic recording dielectric belt or the like).

According to the present invention, it is possible to suppress the waving of the surface of the transfer belt on which the recording material is conveyed, while suppressing the permanent deformation of the transfer roller.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-010625 filed on Jan. 27, 2024, which is hereby incorporated by reference herein in its entirety.

What is claimed is:

1. An image forming apparatus comprising:
a rotatable image bearing member configured to bear a toner image;
an endless first belt onto which the toner image is transferred from the image bearing member;
a driving roller configured to drive the first belt;
a first driving source configured to drive the driving roller;
an inner roller configured to contact an inner surface of the first belt;
an endless second belt configured to convey a recording material and configured to form a transfer portion where the toner image is transferred from the first belt onto the recording material;
a transfer roller configured to contact an inner surface of the second belt and configured to nip the first belt and the second belt between itself and the inner roller and configured to form the transfer portion;
a downstream roller provided so as to contact an inner peripheral surface of the second belt on a side downstream of the transfer roller with respect to a recording material conveying direction and configured to form a surface, on which the recording material is conveyed, between itself and the transfer roller; and
a second driving source configured to rotationally drive the downstream roller,
wherein during transfer in which the toner image is transferred onto the recording material, a surface speed of the downstream roller is set so as to become higher than an inner peripheral surface speed of the second belt.

2. An image forming apparatus according to claim 1, wherein the transfer roller includes an elastic layer of 25° or more and 50° or less in Asker-C hardness.

3. An image forming apparatus according to claim 1, wherein during the transfer in which the toner images transferred onto the recording material, a number of rotations of the second driving source is set so that a speed difference of a surface speed of the downstream roller to an inner peripheral surface speed of the second belt becomes 5% or more and 50% or less.

4. An image forming apparatus according to claim 3, wherein the number of rotations of the second driving source is set so that the speed difference becomes 10% or more.

5. An image forming apparatus according to claim 1, further comprising a torque limiter provided in a drive transmitting portion for transmitting a driving force from the second driving source to the downstream roller.

6. An image forming apparatus according to claim 5, wherein the torque limiter is constituted so that during the transfer in which the toner image is transferred onto the recording material, a state in which the downstream roller is driven at a torque within a limit torque is maintained so that the surface speed of the downstream roller becomes faster than the inner peripheral surface speed of the second belt.

7. An image forming apparatus according to claim 1, wherein the second belt is supported by two rollers of the transfer roller and the downstream roller.

8. An image forming apparatus according to claim 1, wherein as viewed substantially parallel to a rotational axis direction of the transfer roller, when
lengths of two line segments, each including end points which are intersection points with outer diameter circles of the transfer roller and the downstream roller, in two tangential lines circumscribed with the outer diameter circles of the transfer roller and the downstream roller so as not to intersect each other are L1 and L2, respectively,
lengths of two arcs along the outer diameter circles of the transfer roller and the downstream roller, respectively, so as to connect between the end points of the two line segments on a transfer roller side and so as to connect between the end points of the two line segments on a downstream roller side are L3 and LA, respectively, and
an axis-to-axis distance between the transfer roller and the downstream roller in a case where a length of a sum of L1, L2, L3, and LA is equal to an inner peripheral length of the second belt is L,
the transfer roller and the downstream roller are provided in positions so that the axis-to-axis distance becomes L±5%.

9. An image forming apparatus according to claim 1, wherein during the transfer in which the toner image is transferred onto the recording material,
when an outer surface speed of the first belt is V1, the inner peripheral surface speed of the second belt is V2, and the surface speed of the downstream roller is V3, the following relationship is satisfied:
$$V 3 > V 1 \geq V 2 .$$

10. An image forming apparatus according to claim 8, wherein the length of the sum of L1, L2, L3, and L4 is the inner peripheral length or less of the second belt.

11. An image forming apparatus comprising:
a rotatable image bearing member configured to bear a toner image;
an endless first belt onto which the toner image is transferred from the image bearing member;
an inner roller configured to contact an inner surface of the first belt;
an endless second belt configured to convey a recording material and configured to form a transfer portion where the toner image is transferred from the first belt onto the recording material;
a transfer roller configured to contact an inner surface of the second belt and configured to nip the first belt and the second belt between itself and the inner roller and configured to form the transfer portion;
a downstream roller provided so as to contact an inner peripheral surface of the second belt on a side downstream of the transfer roller with respect to a recording material conveying direction and configured to form a surface, on which the recording material is conveyed, between itself and the transfer roller;
a first driving source configured to rotationally drive the transfer roller; and
a second driving source configured to rotationally drive the downstream roller,
wherein during transfer in which the toner image is transferred onto the recording material, a surface speed of the downstream roller is set so as to become higher than an inner peripheral surface speed of the second belt.

12. An image forming apparatus according to claim 11, wherein the transfer roller includes an elastic layer of 25° or more and 50° or less in Asker-C hardness.

13. An image forming apparatus according to claim 11, wherein during the transfer in which the toner images transferred onto the recording material, a number of rotations of the second driving source is set so that a speed difference of a surface speed of the downstream roller to an inner peripheral surface speed of the second belt becomes 5% or more and 50% or less.

14. An image forming apparatus according to claim 13, wherein the number of rotations of the second driving source is set so that the speed difference becomes 10% or more.

15. An image forming apparatus according to claim 13, wherein the number of rotations of the second driving source is set so that the speed difference becomes 15% or more.

16. An image forming apparatus according to claim 11, further comprising a torque limiter provided in a drive transmitting portion for transmitting a driving force from the second driving source to the downstream roller.

17. An image forming apparatus according to claim 16, wherein the torque limiter is constituted so that during the transfer in which the toner image is transferred onto the recording material, a state in which the downstream roller is driven at a torque within a limit torque is maintained so that the surface speed of the downstream roller becomes faster than the inner peripheral surface speed of the second belt.

18. An image forming apparatus according to claim 11, wherein the second belt is supported by two rollers of the transfer roller and the downstream roller.

19. An image forming apparatus according to claim 11, wherein as viewed substantially parallel to a rotational axis direction of the transfer roller, when
lengths of two line segments, each including end points which are intersection points with outer diameter circles of the transfer roller and the downstream roller, in two tangential lines circumscribed with the outer diameter circles of the transfer roller and the downstream roller so as not to intersect each other are L1 and L2, respectively,
lengths of two arcs along the outer diameter circles of the transfer roller and the downstream roller, respectively, so as to connect between the end points of the two line segments on a transfer roller side and so as to connect between the end points of the two line segments on a downstream roller side are L3 and LA, respectively, and
an axis-to-axis distance between the transfer roller and the downstream roller in a case where a length of a sum of L1, L2, L3, and L4 is equal to an inner peripheral length of the second belt is L,
the transfer roller and the downstream roller, respectively, are provided in positions so that the axis-to-axis distance becomes L±5%.

20. An image forming apparatus according to claim 19, wherein the length of the sum of L1, L2, L3, and L4 is the inner peripheral length or less of the second belt.

21. An image forming apparatus according to claim 11, wherein during the transfer in which the toner image is transferred onto the recording material,
when a surface speed of the transfer roller is V4, the inner peripheral surface speed of the second belt is V2, and the surface speed of the downstream roller is V3, the following relationship is satisfied:
$$V 3 > V 4 \geq V 2 .$$
